(19) United States
(12) Patent Application Publication
(10) Pub. No.: US 2007/0192585 A1
(43) Pub. Date: Aug. 16, 2007

(54) Method and apparatus for processing data in a wireless communication system

(75) Inventors: Alain Charles Louis Briancon, Poolesville, MD (US); Shamim Akbar Rahman, Montreal (CA); Maged Zaki, Pierrefonds (CA); Guy Cote, Boucherville (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/318,317

(22) Filed: Dec. 23, 2005

Related U.S. Application Data
(60) Provisional application No. 60/715,325, filed on Sep. 8, 2005.

(51) Int. Cl. H04L 9/00

(52) U.S. Cl. 713/152

(57) ABSTRACT

In a wireless communication system comprising at least one wireless transmit/receive unit (WTRU) and a trusted entity, a method and apparatus for processing data during an event, includes storing data in a memory of the WTRU. The stored data is classified in the memory of the WTRU. The WTRU detects an event and transmits a notification signal to the trusted entity in response to the event detected. The trusted entity transmits a readiness signal to the WTRU. The WTRU transmits data classified for transfer to the trusted entity, and the trusted entity stores the data classified for transfer in a memory of the trusted entity.

### CROSS REFERENCED TO RELATED APPLICATIONS

This application claims the benefit of U.S. Provisional Application No. 60/715,325, filed on Sep. 8, 2005, which is incorporated by reference herein as if fully set forth.

### FIELD OF INVENTION

The present invention relates to wireless communications systems. More particularly, the present invention relates to a method and apparatus for processing data in a wireless communication system.

### BACKGROUND

Data is the lifeblood of modern business. Corporations often go to great lengths to protect their data and keep it secure from hackers. To keep data secure, multiple levels of security are often implemented on corporate networks to prevent unauthorized access to data. Advancements in mobile technology, however, have shifted a large amount of data storage onto mobile devices, such as laptop computers, Personal Data Assistants (PDAs), wireless transmit/receive units (WTRUs) and the like. Given the memory capacities of these devices and the ability to network large numbers of them together to share, and/or store data gives these devices a nearly infinite storage ability. As a result, many employees, and in particular many high level employees, store ever increasing amounts of sensitive data on these devices.

The possibility therefore of having data compromised is now greater due to the potential for one of these devices to fall into the wrong hands. Additionally, the data could face loss in the event of a catastrophic event such as a flood or fire. Since some of this data may be critical enough that the loss of it could seriously harm the functioning of a business, its loss could be catastrophic.

Currently, to combat data on WTRUs having a nearly infinite storage capacity from being compromised, some simple mechanisms are used to destroy data if security is breached on the device. These current methods typically involve actions such as destroying the data after a certain number of failed password attempts. However, in the infinite storage realm, where all users' confidential and important data may be stored on one device, the loss of all data on that device can be catastrophic, as previously stated. In addition, the current methods do not involve activities such as tracking user activities and behavior to detect the security breach nor do the current methods contain criteria for processing data and taking action based on the types of data stored and the severity level of the security breach, let alone processing data on the device if the device is subjected to catastrophic conditions.

There is a need, therefore, for a method and apparatus for processing data during a detected event such as a security breach or the like in a more effective and efficient manner, and for processing the potential loss of data on a device subjected to catastrophic conditions such as a flood or fire.

### SUMMARY

In a wireless communication system comprising at least one wireless transmit/receive unit (WTRU) and a trusted entity, a method and apparatus for processing data during an event, includes storing data in a memory of the WTRU. The stored data is classified in the memory of the WTRU. The WTRU detects an event and transmits a notification signal to the trusted entity in response to the event detected. The trusted entity transmits a readiness signal to the WTRU. The WTRU transmits data classified for transfer to the trusted entity, and the trusted entity stores the data classified for transfer in a memory of the trusted entity.

### BRIEF DESCRIPTION OF THE DRAWINGS

The foregoing summary, as well as the following detailed description of the preferred embodiments of the present invention will be better understood when read with reference to the appended drawings, wherein:

FIG. 1 is a wireless communication system configured in accordance with the present invention;

FIG. 2 is a functional block diagram of a WTRU and an Access Point (AP) of the wireless communication system of FIG. 1;

FIG. 3 is a functional block diagram of a pair of WTRUs of the wireless communication system of FIG. 1;

FIG. 4 is a flow diagram depicting a method of processing data between a WTRU and a trusted entity in accordance with the present invention;

FIG. 5 is a flow diagram depicting an alternative method of processing data in a WTRU in accordance with the present invention;

FIG. 6 is a functional block diagram of a WTRU containing a security agent to process data in accordance with the present invention; and

FIG. 7 is a functional block diagram of an AP containing a security agent in accordance with the present invention.

### DETAILED DESCRIPTION OF THE PREFERRED EMBODIMENTS

Hereafter, a mobile infinite storage device includes but is not limited to a user equipment, a wireless transmit/receive unit (WTRU), mobile station, fixed or mobile subscriber unit, pager, or any other type of device capable of operating in a wireless environment. When referred to hereafter, an access point (AP) includes, but is not limited to a base station, a Node-B, site controller, or any other type of interfacing device in a wireless environment.

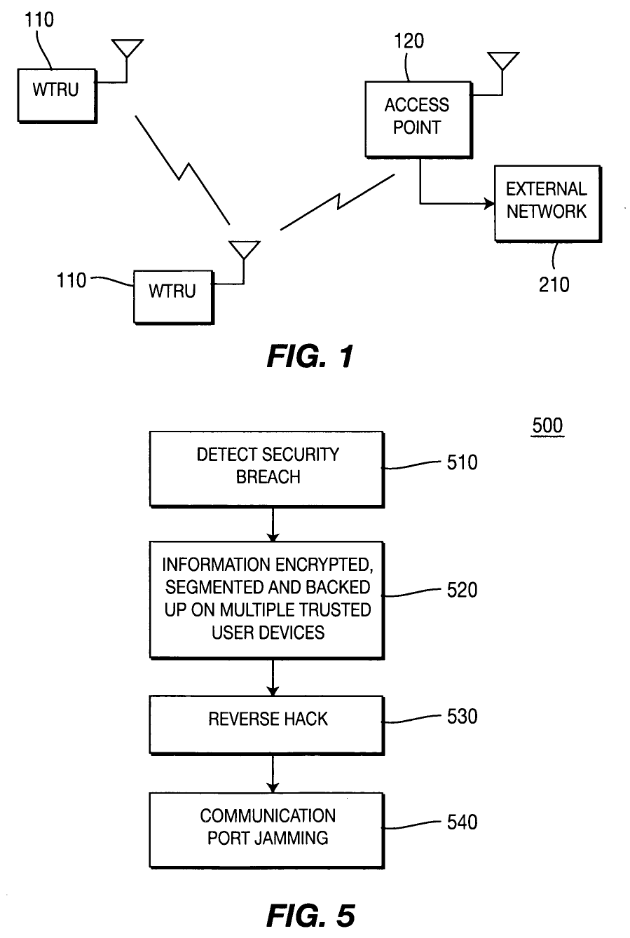

Referring now to the drawings, wherein like reference numerals refer to similar components across the several views, and in particular to FIG. 1, a wireless communication system 100 for implementing a method of processing data in a WTRU, in accordance with the present invention is shown. The wireless communication system 100 includes a plurality of WTRUs 110 and an AP 120, in wireless communication with one another. Additionally, the AP 120 may be connected to an external network 210, such as the Internet or the like.

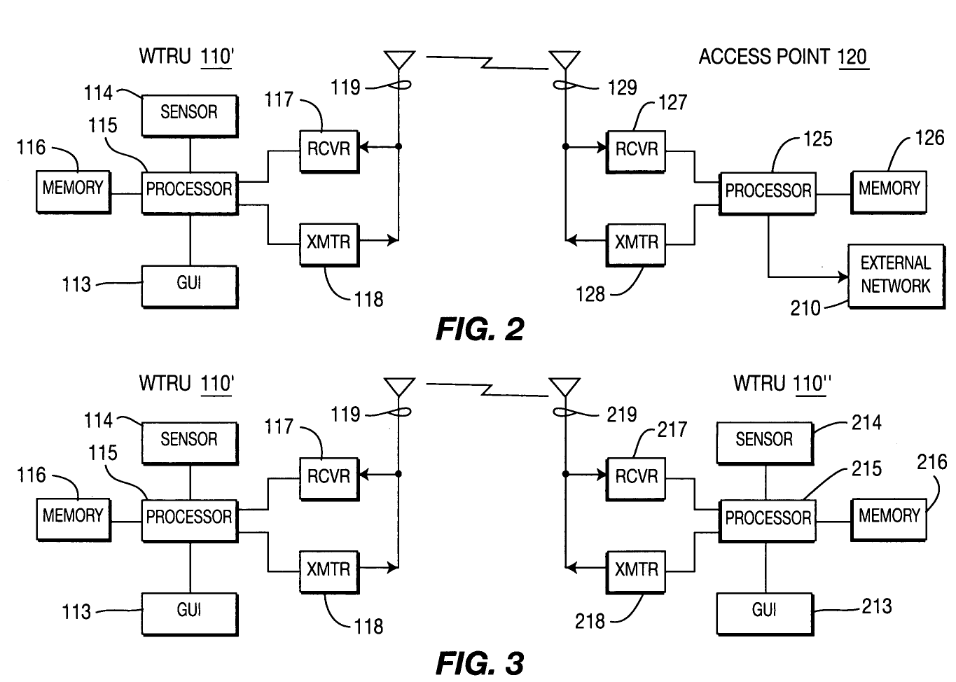

FIG. 2 is a functional block diagram of a WTRU 110 (referenced as WTRU 110′) in communication with an AP 120 and being configured to process data in accordance with the present invention. Moreover, in accordance with the present invention, the WTRU 110′ and the AP 120 have a pre-established trusted relationship such that the WTRU 110′ will recognize the AP 120 as a trusted entity with which to communicate in the event that data processing procedures are commenced on the WTRU 110′. For instance, the trusted AP 120 can be an access point at home or certain access points in the same office that the WTRU 110′ has authenticated as a trusted entity beforehand. The pre-established trust relationship may be established in a number of ways. For example, in one embodiment, the WTRU 110′ may attempt to connect to a wireless network via the access point 120. When the WTRU 110′ attempts to establish the connection, it may broadcast an encryption key to authenticate the WTRU 110′ to the AP 120. If the AP 120 and the WTRU 110′ utilize the same encryption key, then the AP 120 and the WTRU 110′ may consider each other as trusted entities and a trust relationship will exist between the WTRU 110′ and the AP 120.

Additionally, during the establishment of the trusted relationship between the WTRU 110′ and the AP 120, the WTRU 110′ may transfer existing data to be stored in the memory 126 of the AP 120. In this manner, if the WTRU 110′ detects an event later that requires the transfer of data to the AP 120, the WTRU 110′ need only transfer data to the AP 120 that has been added and/or changed to the memory 116 of the WTRU 110′ from the original data stored in the memory 126 of the AP 120.

In addition to the components normally included in a typical WTRU, the WTRU 110′ includes a processor 115 for processing data, a memory 116 in communication with the processor 115, a receiver 117 in communication with the processor 115, a transmitter 118 in communication with the processor 115, an antenna 119 in communication with both the receiver 117 and the transmitter 118 to facilitate the transmission/reception of wireless data, and a graphical user interface (GUI) 113, in communication with the processor 115, to interface with the processor 115. A sensor 114, in communication with the processor 115, which detects catastrophic conditions, such as a catastrophic flood or fire, may also be included. Additionally, the WTRU 110′ may include a global positioning system (GPS) (not shown) to facilitate the locating the WTRU 110′ in the wireless communication system 100. The memory 116, in a preferred embodiment of the present invention may be internal to the WTRU 110′. However, the memory 116 may also include a removable storage drive connected to the WTRU 110′

In addition to the components normally included in a typical AP, the AP 120 includes a processor 125 for processing data, a memory 123 in communication with the processor 125, a receiver 127 in communication with the processor 125, a transmitter 128 in communication with the processor 125, and an antenna 129 in communication with both the receiver 127 and the transmitter 128 to facilitate the transmission/reception of wireless data. Additionally, the processor 125 may be in communication with the external network 210.

FIG. 3 is a functional block diagram of a pair of WTRUs 110 (referenced as WTRU 110′ and WTRU 110″), configured to process data, in accordance with the present invention. For purposes of example, The WTRU 110′ and the WTRU 110″ are substantially similar units, however, WTRU 110′ is shown operating as a first WTRU under an event requiring the processing of data, and the WTRU 110″ is shown as a second WTRU in communication with the first WTRU 110′ to receive and process data being transmitted by the first WTRU 110′. Similarly to the pre-established trusted relationship between the WTRU 110′ and the AP 120 of FIG. 2, the WTRU 110′ and the WTRU 110″ have a pre-established relationship, such that the WTRU 110′ will consider the WTRU 110″ to be a trusted entity with which the WTRU 110′ can communicate when commencing data processing procedures. A specific example of a trusted WTRU 110″ might be a WTRU possessed by one of a group of employees traveling together in a mass transit vehicle.

Again, the pre-established trust relationship may be established in a number of ways. For example, the WTRU 110′ may attempt to connect to the WTRU 110″. When the WTRU 110′ attempts to establish the connection, it may broadcast an encryption key to authenticate the WTRU 110′ to the WTRU 110″. If the WTRU 110″ and the WTRU 110′ utilize the same encryption key, then the WTRU 110″ and the WTRU 110′ may consider each other as trusted entities and a trust relationship will exist between the WTRU 110′ and the WTRU 110″.

Similarly to the WTRU 110′, in addition to the components normally included in a typical WTRU (such as an input device), the WTRU 110″ includes a processor 215 for processing data, a memory 216 in communication with the processor 215, a receiver 217 in communication with the processor 215, a transmitter 218 in communication with the processor 215, a sensor 214 in communication with the processor which detects catastrophic conditions, such as a catastrophic flood or fire, an antenna 219 in communication with both the receiver 217 and the transmitter 218 to facilitate the transmission/reception of wireless data, and a graphical user interface (GUI) 213, in communication with the processor 215 to interface with the processor 215.

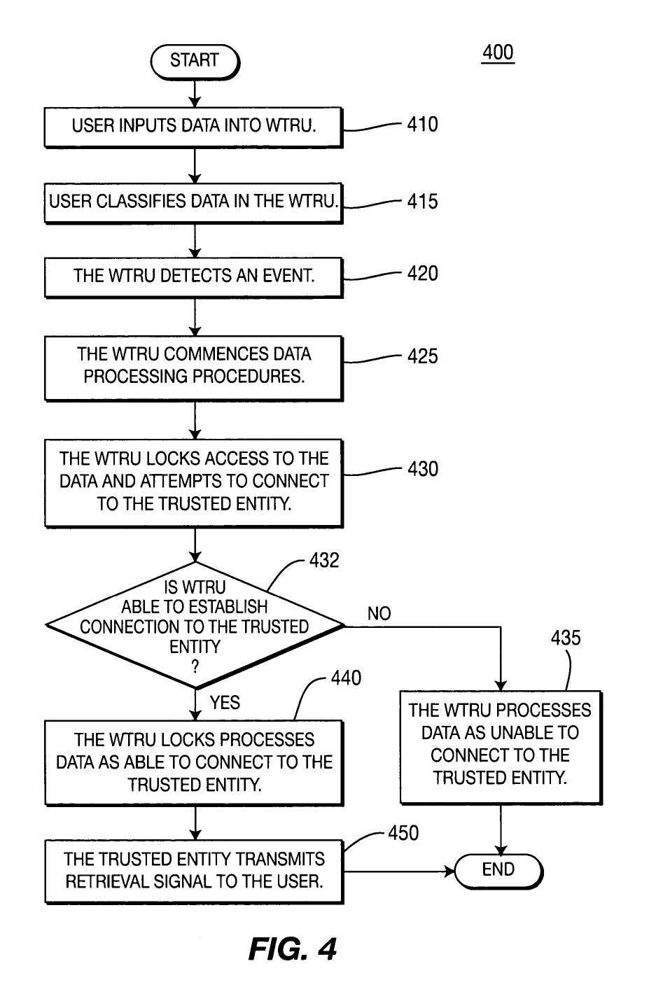

FIG. 4 shows a preferred method of processing data 400 in accordance with the present invention. In step 410, data is input and into the WTRU 110′. In a preferred embodiment of the present invention, the data may be input through a typical input device (e.g. keyboard, mouse, and the like) through the GUI 113 into the processor 115 for transfer to the memory 116. However, the data may be input and into the WTRU 110′ by any method known to one of ordinary skill in the art, such as downloading the data, or the like.

The data input into the WTRU 110′ is then classified (step 415) in order to instruct the processor 115 how to process the data. In general, the data is classified as public data or confidential data. Moreover, confidential data may be classified further with regard to the sensitivity level of the confidential data and the severity of any security breach on the WTRU 110′. For example, the sensitivity level of the confidential data may include top secret, sensitive, and critical, while the classification of a security breach may be a low, medium, or high level breach, which may be determined by a variety of factors. For example, a low level security breach may occur when a user of the WTRU 110′ attempts to access the confidential data and is unable to enter a required password a pre-determined number of times. A medium level security breach may include an instance where a user is unable to provide an authentic voice pattern to a voice recognition sensor operatively connected to the WTRU 110′. A high level security breach may encompass a user of the WTRU 110′ attempting to remove a fixed memory device within the WTRU 110′ that was not intended for removal, or any other attempt by a user to modify the hardware of the WTRU 110′. It can be seen by one of ordinary skill in the art that a variety of conditions may be classified as “low”, “medium” or “high” level security breaches. For example a combination of a low and medium level security breach may constitute a high level security breach.

In an embodiment of the present invention, data classification on the WTRU 110′ can be effected by using a content classifier application running on the processor 115. In order to classify data, the content classifier application may include two parts, a knowledge part and a storage maintenance part.

The knowledge part can identify the kind of data being classified. For example, the knowledge part can determine if the data is an e-mail, photograph, adobe acrobat file, powerpoint document, word document, or any file format known to one of ordinary skill in the art. The knowledge part of the content classifier application can further be trained to build the knowledge base or it can learn as part of the analysis. For example, the knowledge part may track the behavior of the authorized user in order to compare that behavior against detected behavior. Depending on the type of data, and possibly on other data such as its origin, destination, and sensitivity, the content classifier application may contact a policy manager application. The policy manager application will analyze the data received from the knowledge part and send the security classification to the knowledge part of the content classifier application as to whether the data should be classified critical, sensitive, top secret, public, or the like, based on criteria established in the policy manager application.

In a preferred embodiment of the present invention, the policy manager application can allow users to define the policy associated with types of data and the kind of processing expected in case of a security breach. This can take the form of simple markup language and defining the security requirements in terms of classification provided to the content classifier application. The policy manager application can respond to the request sent by the content classifier application for security treatment and special processing. The policy manager application may also run on the processor 115, in a preferred embodiment of the present invention.

In order to facilitate data classification, the content classifier application may manage different storage areas within the memory 116 of the WTRU 110′ for different data depending on its security classification. Maintaining special and designated areas for different kinds of data in the storage maintenance area can aid in later stages if the need arises to destroy or transfer the data in case of a security breach. Additionally, a time delay may be classified onto the data such that the time delay to commence processing the data on the WTRU 110′ decreases depending on the classification of the data and whether or not the WTRU 110′ is able to establish a connection to the trusted entity.

In step 420, the processor 115 of the WTRU 110′ detects an event that triggers the processor 115 to commence processing data stored in the memory 116. The event may be a security breach on the WTRU 110′, a manual trigger, or an emergency condition, in addition to any other event known to one of ordinary skill in the art that might be detected.

The manual trigger can be activated locally or remotely to cause the WTRU 110′ to attempt connection to the trusted entity. The manual trigger can be physically connected to WTRU 110′ to be actuated by the user at the WTRU 110′ itself, or the manual trigger may be located remotely to the WTRU 110′ and able to communicate the trigger to the WTRU 110′.

In a preferred embodiment, the remote manual trigger could be in wireless communication with the WTRU 110′. The implementation of the manual trigger may contain biometric sensors to authenticate the user activating the trigger, or the trigger can be implemented via a keypad that causes the processor 115 to consider a security breach based on a code, such as a Personal Identification Number (PIN), or a voice sensor utilizing voice profile analysis.

More specifically, if the sensor 114 of the WTRU 110′ detects a catastrophic event, such as a flood or fire, then the sensor 114 signals that event to the processor 115 to commence processing data.

A security breach may be detected in a variety of ways known to one of ordinary skill in the art. For example, a security breach may occur when an unauthorized attempt is made to access the WTRU 110′ or the confidential data on the WTRU 110′. In one embodiment, the WTRU 110′ may require authentication by the user before allowing access to confidential data in the memory 116. When the user attempts to access the confidential data via the GUI 113, the processor 115 requires that the user authenticate himself before providing access to the confidential data stored in the memory 116. For example, the processor 115 may require that the user enter a password to access the confidential data, and if the user is unable to enter the correct password after a pre-determined amount of times, the processor 115 may consider that the user is trying to breach security and commence processing the data in the memory 116 of the WTRU 110′.

A security breach may also occur if a user attempts to remove the memory 116 in the form of a removable storage drive. For example, the processor 115 may require the user to authenticate himself upon an attempt to disconnect the removable storage drive from the processor 115. If the user cannot authenticate himself, then the processor 115 may consider it to be a security breach and commence data processing procedures.

Another way in which the processor 115 may detect a security breach is if a signal is transmitted from another wireless device (not shown) to the processor 115 of the WTRU 110′ via the antenna 119 and the receiver 117 that requests access to the confidential data stored in the memory 116. The processor 115 may consider this attempt to be a breach of security and commence data processing procedures. Alternatively, the processor 115 may transmit a request for authentication to the device requesting access via the transmitter 118 and the antenna 119. The authentication may be similar to the authentication described above for a user attempting to access the confidential data through the GUI 113.

An additional parameter could be to track the user's habits relating to how he operates the WTRU 110′, and if the user performs unusual transactions on the device, or physically moves the WTRU 110′ to unusual locations, the processor 115 may consider it to be a breach of security as well and may require authentication by the user.

Another way of achieving this might be to have the user provide a dedicated password to the processor 115 through the GUI 113 that only the authorized user should know. This password would, in a preferred embodiment, differ from any one used as the normal password to log in to the WTRU 110′. Alternatively, a biometric scanner (not shown) could be operatively connected to the processor to read, for example, a fingerprint, or scan the iris or retina of the user to authenticate him.

If the user is able to authenticate to the processor 115, then no data processing procedures need be commenced and access to the data may be granted. However, in the case of either the detection of an emergency condition or a user/requestor of confidential data that is unable to authenticate (i.e. a security breach is detected), the processor 115 commences data processing procedures (step 425) in accordance with the present invention.

In step 430, the processor 115 locks access to the confidential data stored in the memory 116 of the WTRU 110′ and attempts to connect to a trusted entity, such as the AP 120, or alternatively to the WTRU 110″. In a preferred embodiment of the present invention, the WTRU 110′ may attempt to first connect to the AP 120 after commencing data processing procedures in step 425, and attempt to connect to the WTRU 110″ after an unsuccessful attempt to connect to the AP 120.

The processor 115 of the WTRU 110′ transmits a signal to the trusted entity via the transmitter 118 and the antenna 119, and awaits a response from the trusted entity as to whether a connection is established. The processor 115 then determines how to process the data in the memory 116 depending on whether a connection can be established with the trusted entity (step 432). The user of the WTRU 110′ is notified of the attempt by the WTRU 110′ to connect with the trusted entity while the WTRU 110′ is attempting to establish the connection. For example, an icon can be displayed somewhere on the display screen of the WTRU 110′ to alert the user that the WTRU 110′ is attempting to connect to the trusted entity. However any method of notifying the user known to one of ordinary skill in the art may be used.

If the WTRU 110′ is unable to connect to the trusted entity (either the AP 120 or the WTRU 110″ does not respond to the WTRU 110′), then the WTRU 110′ will process the data in accordance with Table 1 below (step 435).

TABLE 1
WTRU 110′ Unable to Connect to Trusted Entity

Security Breach Level

| | | Low | Medium | High |
|---|---|---|---|---|
| Data | Critical | Encrypt | Encrypt | Encrypt |
| Classification | Sensitive | Encrypt | Encrypt | destroy |
| | Top | Encrypt | destroy | destroy |
| | Secret | | | |

Accordingly, Table 1 illustrates a preferred procedure for data processing in a WTRU 110′ unable to connect to the trusted entity. The data in the memory 116 of the WTRU 110′ is processed in accordance with the classification of the data and the severity level of the security breach. Data which is classified as critical, under any level of security breach is encrypted. Data classified as sensitive is encrypted during a low or medium level security breach, and destroyed in case of a high level security breach. Top secret classified data is encrypted during a low level security breach, and destroyed during a medium or high level security breach.

If the WTRU 110′ is able to connect to the trusted entity (either the AP 120 or the WTRU 110″), then the processor 115 of the WTRU 110′ commences the procedure for processing data stored in the memory 116 of the WTRU 110′ in accordance with Table 2 below (step 440).

TABLE 2
WTRU 110′ Connected to Trusted Entity

| | | Security Breach Level | | |
|---|---|---|---|---|
| | | Low | Medium | High |
| Data | Critical | Encrypt on | Encrypt on | Transfer to the |
| Classi- | | WTRU | WTRU | Trusted Entity |
| fication | | | | & destroy on |
| | | | | WTRU |
| | Sensi- | Encrypt on | Transfer to the | Transfer to the |
| | tive | WTRU | Trusted Entity | Trusted Entity |
| | | | & destroy on | & destroy on |
| | | | WTRU | WTRU |
| | Top | Transfer to the | Transfer to the | Destroy on |
| | Secret | Trusted Entity | Trusted Entity | WTRU |
| | | & destroy on | & destroy on | |
| | | WTRU | WTRU | |

Accordingly, Table 2 illustrates a preferred procedure for processing data in the memory 116 of the WTRU 110′ when the WTRU 110′ is able to establish a connection with the trusted entity. Data classified as critical is encrypted on the WTRU 110′ but not transferred to the trusted entity for a low or medium level security breach. Data classified as critical is transferred to the trusted entity and destroyed on the WTRU 110′ in the case of a high level security breach. Data classified as sensitive is encrypted on the WTRU 110′ but not transferred to the trusted entity in the case of a low level security breach. Data classified as sensitive is transferred to the trusted entity and destroyed on the WTRU 110′ in the case of a medium or high level security breach. Top secret classified data is transferred to the trusted entity and destroyed on the WTRU 110′ for a low or medium level security breach. However, during a high level security breach, data classified as top secret is merely destroyed on the WTRU 110′ without transferring the data to the trusted entity.

During a detected emergency condition, the WTRU 110′ may attempt to transfer all critical, sensitive and top secret data to the trusted entity. In this instance, since the WTRU 110′ itself may face destruction, energy resources may be more effectively utilized to power the components of the WTRU 110′ to transfer data to the trusted entity rather than in destroying any data.

Referring again to FIG. 2, when the WTRU 110′ detects an event in step 420 of FIG. 4, the processor 115 of the WTRU 110′ transmits a notification signal to the AP 120 via the transmitter 118 and the antenna 119. The notification signal transmitted to the AP 120 indicates that an event has been detected (for example, a security breach, a manual trigger, or an emergency condition detected via the sensor 114). The receiver 127 of the AP 120 receives the notification signal via the antenna 129 and transfers the notification signal to the processor 125. If a pre-established trust relationship between the AP 120 and the WTRU 110′ exists, the processor of the AP 120 transmits a readiness signal to the WTRU 110′ through the transmitter 128 and the antenna 129 to indicate to the WTRU 110′ the AP 120's readiness to receive the transmission of data from the WTRU 110′. At this time, the processor 125 of the AP 120 may also re-allocate radio resources in the wireless communication system 100 to give priority to the WTRU 110′ to transmit data. For example, a radio resource management (RRM) application may run on the processor 125 of the AP 120 to allocate resources accordingly.

The receiver 117 of the WTRU 110′ receives the readiness signal from the AP 120 via the antenna 119 and transfers the readiness signal to the processor 115. The processor 115 extracts the data classified for transfer to the trusted entity from the memory 116 and transmits the data to the AP 120 through the receiver 117 and the antenna 119. In a preferred embodiment of the present invention, the transmitted data may be compressed and/or encrypted by the processor 115 prior to transmitting the data to the AP 120. The processor 115 then encrypts or destroys the data in the memory 116 of the WTRU 110′ according to its classification in Table 2 above. The receiver 127 of the AP 120 receives the transmitted data from the WTRU 110′ via the antenna 129 and transfers it to the processor 125, which then stores the data in the memory 126.

In a preferred embodiment of the present invention, the WTRU 110′ attempts to establish a connection with the WTRU 110″ in case the WTRU 110′ cannot establish a connection with the AP 120. Accordingly, referring again to FIG. 3, after the processor 115 of the WTRU 110′ detects an event (step 420), the processor 115 transmits a notification signal to the WTRU 110″ via the transmitter 118 and the antenna 119 to notify the WTRU 110″ of the detection of an event. The receiver 217 of the WTRU 110″ receives the notification signal from the WTRU 110′ via the antenna 219 and transfers it to the processor 215. If a pre-established trust relationship exits between the WTRU 110′ and the WTRU 110″, then the processor 215 transmits a readiness signal to the WTRU 110′ via the transmitter 128 and the antenna 129 to indicate to WTRU 110′ WTRU 110″s readiness to receive the transmission of data from WTRU 110′.

The receiver 117 of the WTRU 110′ receives the readiness signal from the WTRU 110″ via the antenna 119 and transfers it to the processor 115. The processor 115 then extracts the data classified for transfer to the trusted entity from the memory 116 and transmits the data to the WTRU 110″ through the receiver 117 and the antenna 119. In a preferred embodiment of the present invention, the transmitted data may be compressed and/or encrypted by the processor 115 prior to transmitting the data to the WTRU 110″. The processor 115 then encrypts or destroys the data in the memory 116 of the WTRU 110′ according to its classification in Table 2 above. The receiver 217 of the WTRU 110″ receives the transmitted data from the WTRU 110′ via the antenna 219 and transfers it to the processor 215, which then stores the transmitted data in the memory 216.

If the WTRU 110″ is able to establish a connection with the AP 120, then the processor 215 of the WTRU 110″ may transmit a notification signal to the AP 120 via the transmitter 218 and antenna 219 of the WTRU 110″ signaling to the AP 120 that an event has been detected. If a trust relationship has been established between the WTRU 110″ and the AP 120, then the WTRU 110″ may be permitted to transfer the data stored in the memory 126 from the WTRU 110″ to the AP 120 in similar fashion as described above.

Referring back to FIG. 4, in step 450 the processor 125 of the AP 120 transmits a retrieval signal via the external network 210 to the owner of the data stored in the memory 126 of the AP 120. The retrieval signal indicates to the data owner that an event has occurred and that data has been transferred from the WTRU 110′ to the AP 120 and is available for retrieval. The retrieval signal may be transmitted to the owner of the data by any means known to one of ordinary skill in the art. In a preferred embodiment of the present invention, the owner of the data will have indicated to the AP 120 the means in which to notify him of the availability of data when the trust relationship was established between the WTRU 110′ and the AP 120. For example, the retrieval signal may be an email sent to a pre-established mailbox indicating to the owner the availability of the data for retrieval. The AP 120 may also advise the user of partial data updates if communication was lost or the WTRU 110′ was destroyed before it could upload all of the data classified for uploading. Additionally, if the WTRU 110′ is outfitted with a GPS, the AP 120 may notify the user of the location of the WTRU 110′.

If the detected event was a manual trigger, then the AP 120 may also signal an alert to a security entity via the external network 210 that the user of the WTRU 110′ may be in danger. The security entity may receive this signal via a pager, telephone, or other communication device known to one of ordinary skill in the art, in order to allow the security entity to respond.

Once the owner receives the retrieval notification from the trusted entity, the owner may retrieve the stored data in a variety of ways. For example, the location where the uploaded data is stored for retrieval may be accessed via the Internet, wherein the owner of the data could access the location and retrieve the data by entering in a pre-selected password.

FIG. 5 is a flow diagram of a further embodiment of the present invention in which a distributed backup method 500 may be employed to process the data. Once a security breach is detected in step 510, the processor 115 of the WTRU 110′ encrypts and segments the confidential data stored in the memory 116. The processor 115 then attempts to connect with a plurality of trusted entities and transmits different segments to individual trusted entities in step 520. This way, individual users of the individual trusted entities cannot make any sense of the data because they would only have an encrypted portion of the overall data stored on their particular trusted entity. Since the entire encrypted data will not exist on an individual trusted entity, it will be extremely difficult for a hacker to reconstruct the data, similar to giving him one or two pieces of a large jigsaw puzzle.

Alternatively, instead of segmenting the confidential data, the WTRU 110′ might backup the entire data by broadcasting it to multiple trusted entities, which may or may not be required to acknowledge receipt of the data to the WTRU 110′. This would create backup redundancy if any particular link between the WTRU 110′ and any particular trusted entity is severed and the trusted entity is unable to collect a portion of the data. For example, a particular trusted entity may not be powered on at the time of the attempted file transfer, or the user of the trusted entity may power the trusted entity off before the transfer is complete. Once the data is securely backed up on the trusted entities, it can be destroyed on the WTRU 110′.

After the secure backup and local destruction of data, the device can perform the step of reverse hacking 530. In one embodiment, the processor 115 can replace the destroyed data in the memory 116 with either false personal data or an intelligent policing executable. The false personal data is merely meant to mislead a hacker into believing he has acquired useful data, however, the intelligent policing executable is designed to seek out and find the individual attempting to illicitly acquire the data on the mobile infinite storage device. Thus, in addition to learning the location, method and techniques of the attempted hacker passively, the intelligent policing executable attempts to seek out the hacker's device and relay the hacker's data to the network to identify and locate him. Learning the method and technique of the hack can also help strengthen any of the device's firewalls in that the firewall application on the mobile infinite storage device can dynamically download appropriate software from the network by presenting it a profile from the attempted hack.

In step 540, communication port jamming can occur. That is, the specific communication method used by the hacker can be disabled by the processor 115 of the WTRU 110′ immediately, once the security breach is detected. Additionally, the WTRU 110′ can attempt to seek out and jam the hacker's communication links.

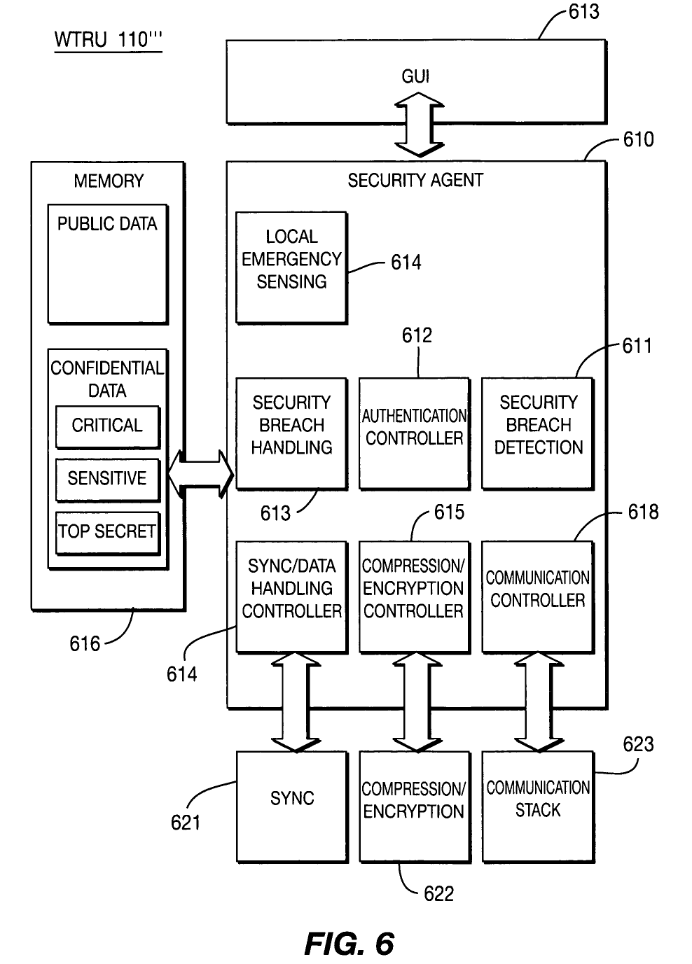

FIG. 6 is a functional block diagram of an alternative embodiment of a WTRU 110′″ configured with a security agent 610 to process information, in accordance with the present invention. The WTRU 110′″ is shown as an example of an alternative embodiment of the present invention in which a security agent 610 runs on a processor similar to the processor 115 in the WTRU 110′. The security agent includes a security breach detection block 611, an authentication controller 612, a security breach handling block 613, a sync/data handling controller 614, a compression/encryption controller 615, and a communication controller 618. A memory 616, containing public data and confidential data (critical, sensitive, and top secret) is in communication with the security agent 610. A GUI 613 interfaces with the security agent 610 in order to allow a user access to the WTRU 110′″, and in particular to allow access to the data stored in the memory 616 of the WTRU 110′″.

For purposes of example only, the WTRU 110′″ operates substantially similarly to the WTRU 110′. The security breach detection block 611 detects security breaches and alerts the security breach handling block 613 to process data in the memory 616 in accordance with the severity of the security attack and the classification of the data. The authentication controller 612 may authenticate the user attempting to access the WTRU 110′″ or the data in the memory 616. Moreover, the authentication controller 612 locks out access to the data if the user is unable to authenticate. If data is to be processed, then the communication controller 618 attempts to establish a connection with the trusted entity via the communication stack 623. Once a connection is made, the sync/data handling controller 614 syncs (621) with the trusted entity and transmits the data according to its classification to the trusted entity. If compression or encryption is required, then the compression/encryption controller 615 provides compression/encryption (622) for the data prior to uploading the data to the trusted entity.

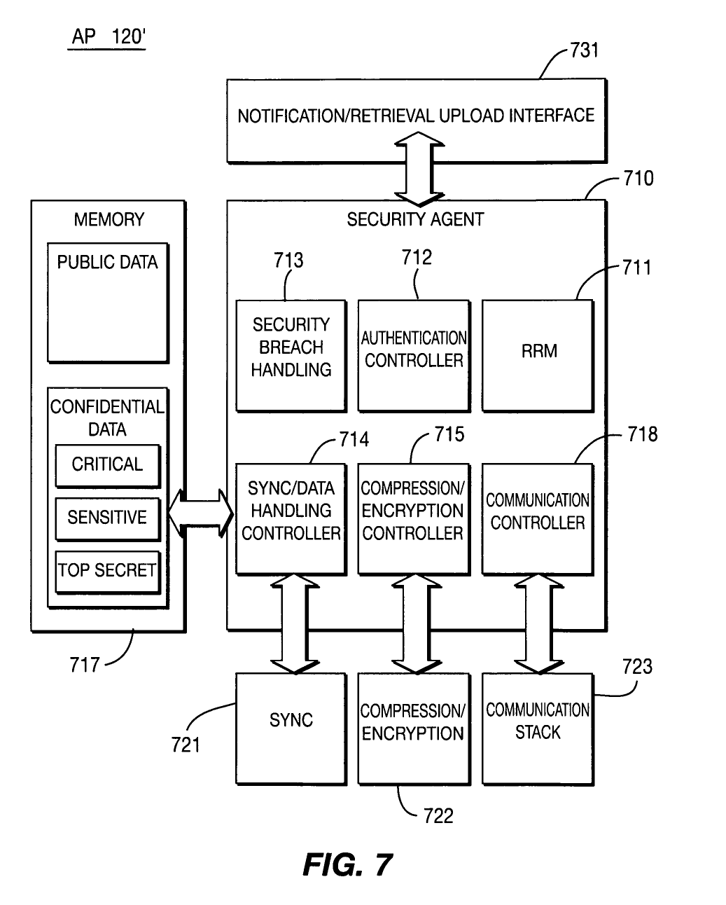

FIG. 7 is a functional block diagram of an alternative embodiment of an AP 120′, having a security agent 710 configured to process data in accordance with the present invention. The AP 120′ includes a memory 717 in communication with the security agent 710 for storing data received from a WTRU, and a notification/retrieval upload interface 731 in communication with the security agent 710 to notify the owner of data uploaded into the memory 717 of the data's availability.

The AP 120′ is shown as an example of an alternative embodiment of an AP in which the security agent 710 runs on a processor similar to the processor 125 in the AP 120. The security agent includes radio resource manager (RRM) 711, an authentication controller 712, a security breach handling block 713, a sync/data handling controller 714, a compression/encryption controller 715, and a communication controller 718. The memory 716, containing public data and confidential data (critical, sensitive, and top secret) is in communication with the security agent 710.

For purposes of example only, the AP 120′ operates substantially similarly to the AP 120. The authentication controller 712 may authenticate the WTRU attempting to access the AP 120′, and upload information to the AP 120′. If data is to be received, then the communication controller 718 establishes a connection with the WTRU sending the data via the communication stack 723. Once a connection is made, the sync/data handling controller 714 syncs (721) with the WTRU and receives the data from the WTRU. If the data was compressed or encrypted (722), then the compression/encryption controller 715 may provide reverse compression/encryption for the data prior to transferring the data to the memory 717. Alternatively, the compression/encryption controller 715 may maintain the compression/encryption on the data.

The content classifier described above may also run on the security agent 610 of the WTRU 110′″ or the security agent 710 of the AP 120′ in a substantially similar manner to the content classifier running on the processor 115 of the WTRU 110′.

Access rights can be changed in a number of different ways. One method may be to simply change the permission bits/files managed by the file system. From a Digital Rights Management (DRM) perspective, destroying all the Rights Objects is a method which is similar to destroying keys for encrypted contents. After Rights Objects are destroyed, for contents managed by DRM systems, the system may send a device certificate revocation, digitally signed by the device. This will put the device in the black list and stop any future communication.

The methods described above may be implemented in a WTRU, a base station or AP configured as the network interface, within an air interface system, including but not limited to WCDMA, TDD, TDSCDMA, FDD, CDMA 2000, GSM, EDG, GPRS, CDMA, TDMA, 802.xx. The present invention applies to the following technologies: future system architecture, RRM and RRC, non-cellular, middleware, and applications. The present invention is applicable to the following wireless layers: Data link layer (L2), Transport layer, session layer, presentation layer, application layer.

Although the features and elements of the present invention are described in the preferred embodiments in particular combinations, each feature or element can be used alone (without the other features and elements of the preferred embodiments) or in various combinations with or without other features and elements of the present invention. For example, in a preferred embodiment of the present invention, the data processing procedure is performed by an application running on the processors of the WTRUs and the AP. However, the data processing procedure may be implemented by any means known to one of ordinary skill in the art. For example, the features of the present invention may be incorporated into an integrated circuit (IC) or be configured in a circuit comprising a multitude of interconnecting components.

What is claimed is:

1. In a wireless communication system comprising at least one wireless transmit/receive unit (WTRU) and a trusted entity, a method for processing data during an event, the method comprising:
storing data in a memory of the WTRU;
classifying the data stored in the memory of the WTRU;
the WTRU detecting an event;
the WTRU transmitting a notification signal to the trusted entity in response to the event detected;
the trusted entity transmitting a readiness signal to the WTRU;
the WTRU transmitting data classified for transfer to the trusted entity; and
the trusted entity storing the data classified for transfer in a memory of the trusted entity.

2. The method of claim 1, further comprising the trusted entity transmitting a retrieval signal to a user of the WTRU to notify the user of the data stored in the memory of the trusted entity.

3. The method of claim 1, wherein the trusted entity is an access point (AP).

4. The method of claim 3, wherein the AP is in communication with an external network.

5. The method of claim 4, wherein the external network is the Internet.

6. The method of claim 1, wherein the trusted entity is a second WTRU.

7. The method of claim 1, wherein the step of the WTRU detecting an event includes the WTRU detecting an emergency condition.

8. The method of claim 7, wherein the emergency condition is a flood.

9. The method of claim 7, wherein the emergency condition is a fire.

10. The method of claim 1, wherein the step of detecting an event includes the step of detecting a manual trigger.

11. The method of claim 10, wherein the manual trigger is local to the WTRU.

12. The method of claim 11, wherein the manual trigger includes either biometric sensors to authenticate the user activating the manual trigger, the entry of a code on a keypad, or a voice sensor using voice profile analysis.

13. The method of claim 10, wherein the manual trigger is remote to the WTRU.

14. The method of claim 13, wherein the manual trigger includes either biometric sensors to authenticate the user activating the manual trigger, the entry of a code on a keypad, or a voice sensor using voice profile analysis.

15. The method of claim 10, wherein the step of manually triggering includes the WTRU contacting security services.

16. The method of claim 1, wherein the data is classified as critical, sensitive, or top secret.

17. The method of claim 16, wherein the step of detecting an event includes the step of detecting a security breach on the WTRU.

18. The method of claim 17, wherein the detected event is unusual user behavior.

19. The method of claim 17, wherein the detected event includes detecting a change in the location of the WTRU.

20. The method of claim 17, wherein the detected event includes detecting an attempt to access the critical, sensitive, or top secret data.

21. The method of claim 20, further comprising the step of the WTRU requiring the user to authenticate when attempting to access the critical, sensitive, or top secret data.

22. The method of claim 17, wherein the security breach detected is a low, medium, or high level security breach.

23. The method of claim 22, wherein the WTRU locks access to the data stored in the memory of the WTRU.

24. The method of claim 22, wherein the WTRU encrypts critical data during a low or medium level security breach.

25. The method of claim 22, wherein the WTRU transmits critical data to the trusted entity during a high level security breach.

26. The method of claim 25, wherein the WTRU destroys the critical data in the memory of the WTRU.

27. The method of claim 22, wherein the WTRU encrypts sensitive data during a low level security breach.

28. The method of claim 22, wherein the WTRU transmits sensitive information to the trusted entity during a medium or high level security breach.

29. The method of claim 28, wherein the WTRU destroys the sensitive data in the memory of the WTRU.

30. The method of claim 22, wherein the WTRU transmits top secret data to the trusted entity after during a low or medium level security breach.

31. The method of claim 30, wherein the WTRU destroys the top secret data in the memory of the WTRU.

32. The method of claim 22, wherein the WTRU destroys top secret data in the memory of the WTRU during a high level security breach.

33. The method of claim 1, wherein the WTRU encrypts the data prior to transmitting the data to the trusted entity.

34. The method of claim 1, wherein the WTRU compresses the data prior to transmitting the data to the trusted entity.

35. In a wireless communication system comprising at least one wireless transmit receive unit (WTRU) and a trusted entity, a method for processing data during an event, the method comprising:
storing data in a memory of the WTRU;
classifying the data stored in the memory of the WTRU;
the WTRU detecting an event;
the WTRU transmitting a notification signal to the trusted entity in response to the event detected;
the WTRU receiving no response from the trusted entity; and
the WTRU processing the data in the memory of the WTRU according to the classification of the data.

36. The method of claim 35, wherein the data classification includes at least one of critical, sensitive, and top secret.

37. The method of claim 36, wherein the event detected is a security breach.

38. The method of claim 37, wherein the security breach detected is a low, medium, or high level security breach.

39. The method of claim 38, wherein the WTRU encrypts critical data in the memory of the WTRU during a low, medium, or high level security breach.

40. The method of claim 38, wherein the WTRU encrypts sensitive data in the memory of the WTRU during a low or medium level security breach.

41. The method of claim 38, wherein the WTRU destroys sensitive data in the memory of the WTRU during a high level security breach.

42. The method of claim 38, wherein the WTRU encrypts top secret data in the memory of the WTRU during a low level security breach.

43. The method of claim 38, wherein the WTRU destroys top secret data in the memory of the WTRU during a medium or high level security breach.

44. In a wireless communication system comprising at least one wireless transmit receive unit (WTRU) and a plurality of trusted entities, a method for processing data comprising:
storing data in a memory of the WTRU;
classifying the data stored in the memory of the WTRU;
the WTRU detecting an event;
encrypting and segmenting the data stored in the memory of the WTRU;
the WTRU transmitting a first segment of the data to a first trusted entity; and
the WTRU transmitting additional segments of the data to additional trusted entities.

45. The method of claim 44, further comprising the WTRU destroying the data in the memory of the WTRU.

46. The method of claim 44, further comprising replacing the data stored in the memory of the WTRU with false data.

47. The method of claim 44, further comprising replacing the data stored in the memory of the WTRU with a policing executable.

48. In a wireless communication system comprising at least one wireless transmit receive unit (WTRU) and a trusted device, a method for processing data, comprising:
storing data in a memory of the WTRU;
classifying the data stored in the memory of the WTRU;
the WTRU detecting an attempt by a hacker to access the data in the memory of the WTRU;
the WTRU locking access to the data in the memory of the WTRU; and
the WTRU locating the hacker.

49. The method of claim 48, further comprising the WTRU disabling the communication link between the WTRU and the hacker.

50. The method of claim 48, further comprising a policy manager running on a processor of the WTRU.

51. In a wireless communication system comprising a wireless transmit receive unit (WTRU) and a trusted entity, the WTRU comprising:
a transmitter;
a receiver;
a memory containing classified data; and
a processor, in communication with the transmitter, receiver and memory,
wherein an application runs on the processor to process classified data in the memory, the processor detects an event in the WTRU, the transmitter transmits a notification signal to the trusted entity through the transmitter, the receiver receives a readiness signal from the trusted entity, the transmitter transmits the classified data to the trusted entity.

52. The WTRU of claim 51, further comprising an antenna in communication with the transmitter and the receiver.

53. The WTRU of claim 51, further comprising a sensor in communication with the processor.

54. The WTRU of claim 53, wherein the sensor detects flooding.

55. The WTRU of claim 53, wherein the sensor detects fire.

56. The WTRU of claim 51, further comprising a graphical user interface (GUI) in communication with the processor.

57. In a wireless communication system comprising a WTRU and a trusted entity, the WTRU including an integrated circuit (IC) comprising:
a transmitter;
a receiver;
a memory containing classified data; and
a processor, in communication with the transmitter, receiver and memory,
wherein an application runs on the processor to process classified data in the memory, the processor detects an event in the WTRU, the transmitter transmits a notification signal to the trusted entity through the transmitter, the receiver receives a readiness signal from the trusted entity, the transmitter transmits the classified data to the trusted entity.

58. The IC of claim 57, further comprising an antenna in communication with the transmitter and the receiver.

59. The IC of claim 57, further comprising a sensor in communication with the processor.

60. The IC of claim 59, wherein the sensor detects flooding.

61. The IC of claim 59, wherein the sensor detects fire.

62. The WTRU of claim 57, further comprising a graphical user interface (GUI) in communication with the processor.
